(19) United States
(12) Patent Application Publication
(10) Pub. No.: US 2004/0160523 A1
(43) Pub. Date: Aug. 19, 2004

(54) Video camera

(75) Inventors: Hiroko Mogi, Kanagawa (JP); Toru Kirihara, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/689,703

(22) Filed: Oct. 22, 2003

(30) Foreign Application Priority Data
Oct. 25, 2002 (JP) P2002-311956

(51) Int. Cl. H04N 5/222

(52) U.S. Cl. 348/333.07

(57) ABSTRACT

In a video camera, a viewfinder removed from a viewfinder fixture is mounted, via a bracket, on one end of a first am member fixed pivotably at the other end thereof to the viewfinder fixture. The first arm member is supported at the one end thereof on a second arm member connected to a stationary thing like a tripod.

### BACKGROUND OF THE INVENTION

1. Field of the Invention

The present invention relates to a video camera with a viewfinder.

This application claims the priority of the Japanese Patent Application No. 2002-311956 filed on Oct. 25, 2002, the entirety of which is incorporated by reference herein.

2. Description of the Related Art

The conventional video cameras used at the broadcasting stations, etc., for the purpose of business-grade ENG (electrical news gathering) and the like are designed with a consideration given to positioning and weight balancing of the control system and eyepiece of the viewfinder so that the user can shoot while holding the video camera on his or her shoulder. For example, the eyepiece of the viewfinder of the video camera is located at the front side of the camera body so that when the user holds the camera body on his shoulder, the eyepiece will be positioned just before the user's eye.

However, since the above video camera is designed primarily for the shoulder-held use as above, if a tripod or the like is used to support the camera body, it will be difficult for the user to well position himself or herself in relation to the eyepiece while controlling the camera.

On this account, there has been proposed a long viewfinder larger than a usual one and provided with an eyepiece located nearer, than usual, to the rear end of the camera body. When a tripod or the like is used to support an ENG camera having such a long viewfinder, the user has to look into the eyepiece from the back of the camera. The viewfinder of this type is known, for example, from the disclosure in the Japanese Published Unexamined Patent Application No. H10-191118.

The above large viewfinder is not advantageous in that it is more expensive than the ordinary viewfinder since the optical mechanism is more complicated because it is necessary to optically lead an image displayed on an image display unit such as a CRT (cathode ray tube) or liquid crystal display (LCD) panel to the eyepiece in a location farther than that of the ordinary viewfinder.

Some of such large viewfinders incorporate an LCD panel for display of an image as above, and have installed thereon a finder having a magnification lens provided in the lens-barrel in order to view, in a full field of view, an image being picked up, as the case may be. It should be noted that a video camera using an LCD panel is disclosed in the Japanese Published Unexamined Patent Application No. H10-126656, for example.

The magnification lens included in the finder magnifies an image displayed on the LCD panel for the user's sake, and works as a condenser lens to gather external rays of light for the LCD panel.

The LCD panel consists of liquid crystal layers formed on either side of a synthetic resin sheets. When external light is condensed by the condenser lens onto the resin sheet surface, a burn-in will possibly take place in a light-condensed position. Also, when the finder is left removed from the display unit, a thing under the finder will possibly be burnt.

### OBJECT AND SUMMARY OF THE INVENTION

It is therefore an object of the present invention to overcome the above-mentioned drawbacks of the related art by providing a video camera designed for a standard-size viewfinder to easily be installable in any desired one of various positions on a camera body.

It is another object of the present invention to provide a video camera designed for a standard-size viewfinder to be able to perform functions of a large viewfinder.

It is further object of the present invention to provide a magnifier capable of preventing a liquid crystal display panel from being burned in by a magnification lens incorporated in a finder, a viewfinder with the magnifier, and a video camera with the viewfinder.

The above object can be attained by providing a video camera including according to the present invention:

a camera body to image an object; and

a viewfinder removably installed on the camera body to display an image picked up by the camera body,

the viewfinder including a display unit to display an image thereon, and a mounting member removably installable to a finder fixture on the camera body so that the display unit is pivotably installed on the camera body; and

the camera body having provided thereon an accessory-part fixture for fixing an accessory part to the video camera.

Also, the above object can be attained by providing a magnifier including according to the present invention:

a magnification lens provided in a viewfinder to magnify an image displayed on a display unit; and

a polarization filter provided on an optical path of the magnifier,

and which is removably installable to the viewfinder.

Also, the above object can be attained by providing a viewfinder including according to the present invention:

a display unit having a display screen to display an image; and

a magnifier having a magnification lens to magnify an image displayed on the display screen,

the magnifier having a polarization filter provided on an optical path thereof.

Also, the above object can be attained by providing a video camera including according to the present invention:

a camera body to image an object; and

a viewfinder,

the viewfinder including a display unit having a display screen to display an image thereon; and a magnifier having a magnification lens to magnify an image displayed on the display screen; and

the magnifier having a polarization filter provided on an optical path thereof.

These objects and other objects, features and advantages of the present invention will become more apparent from the following detailed description of the preferred embodiments of the present invention when taken in conjunction with the accompanying drawings.

### BRIEF DESCRIPTION OF THE DRAWINGS

FIG. 1 is a perspective view of the video camera according to the present invention;

FIG. 2 is a perspective view of the viewfinder of the video camera in FIG. 1, showing how the viewfinder is pivoted;

FIG. 3 is a perspective view of the viewfinder of the video camera in FIG. 1, showing how to install and remove the viewfinder;

FIG. 4 is a perspective view of the viewfinder of the video camera in FIG. 1, showing how to install and remove the viewfinder;

FIG. 5 is a perspective view of the viewfinder from the finder block;

FIG. 6 is an exploded perspective view of the viewfinder from the finder block;

FIG. 7 is a plan view of the viewfinder from the LCD panel of the display unit included in the viewfinder;

FIG. 8 is an exploded perspective view of the viewfinder from the camera body;

FIG. 9 is a plan view, from below, of the display unit included in the viewfinder;

FIG. 10 is a perspective view of the viewfinder fixture from the camera body;

FIG. 11 is a plan view of the viewfinder installed to the viewfinder fixture;

FIG. 12 is a sectional view of a pivoting mechanism provided between a stationary portion and pivoting portion;

FIG. 13 is an exploded perspective view of the finder block installed to the display unit included in the viewfinder;

FIG. 14 explains the construction of the finder block of the viewfinder;

FIG. 15 is a perspective view of the viewfinder, explaining how to install and remove the magnifier to and from the finder block;

FIG. 16 explains the finder block being installable to or removable from the display unit of the viewfinder;

FIG. 17 explains the finder block installed and locked to the display unit of the viewfinder;

FIG. 18 is a sectional view taken along the line A-A in FIG. 16;

FIG. 19 is a sectional view taken along the line B-B in FIG. 17;

FIG. 20 explains a hood to be installed to the display unit of the viewfinder;

FIG. 21 explains a magnifier to be installed to the display unit of the viewfinder;

FIG. 22 is a perspective view of the viewfinder with the magnifier going to be installed to or removed from the finder block;

FIG. 23 is a perspective view of the viewfinder with the magnifier installed to the finder block;

FIG. 24 is a schematic block diagram of a control circuit to invert an image displayed on the LCD panel clockwise and counterclockwise;

FIG. 25 explains the installation of the video camera on a tripod with the viewfinder located at a rear portion of the camera body, the video camera being not in any tilted position;

FIG. 26 explains the installation of the video camera on a tripod with the viewfinder located at the rear portion of the camera body, the video camera being in a tilted position;

FIG. 27 is a side elevation of the video camera with the viewfinder installed at the rear portion of the camera body; and

FIG. 28 is a perspective view of the video camera with the viewfinder installed at the rear portion of the camera body, showing another construction of the video camera.

### DESCRIPTION OF THE PREFERRED EMBODIMENTS

The video camera according to the present invention will be described in detail below with reference to the accompanying drawings.

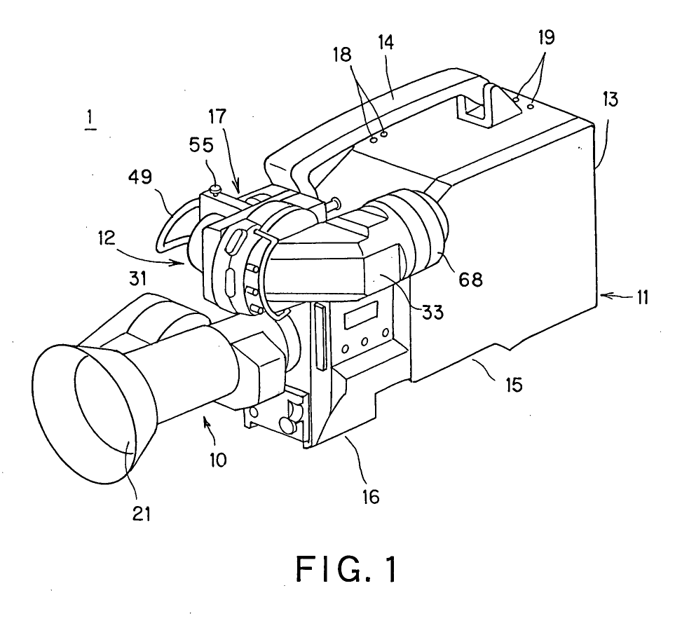

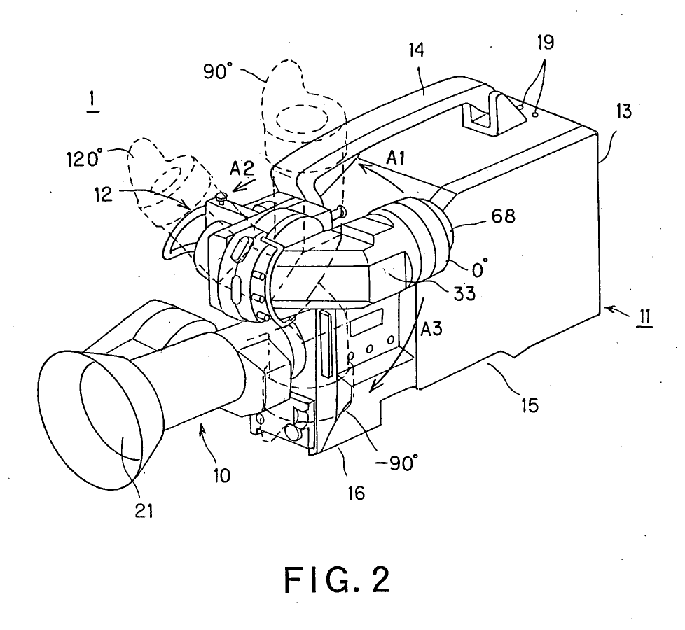

Referring now to FIGS. 1 and 2, there is schematically illustrated the video camera according to the present invention in the form of a perspective view. The video is generally indicated with a reference number 1.

As shown, the video camera 1 includes a lens block 10 incorporating optical members by which an optical image of an object is guided to a camera body 11, the camera body 11 converting the optical image from the lens block 10 into electric signals to produce video signals, a viewfinder 12 to display an image based on the monitoring video signals from the camera body 11, a power unit 13 to supply a power for driving components of the video camera 1, a shoulder pad 15 formed concave on the bottom of the camera body 11 and at which the user holds the camera body 11 on his shoulder, and a handle 14 which is gripped by the user for lifting or carrying the camera body 11.

The lens block 10 includes an imaging lens 21 to gather rays of light from an object. The lens block 10 also includes a zooming mechanism (not shown), for example. By driving the zooming mechanism, it is possible to vary the optical power of the imaging lens 21 within a predetermined range.

As shown in FIGS. 1 to 3, the camera body 11 is shaped to have a generally rectangular parallelepiped shape. One of the longitudinal end faces of the parallelepiped is taken as the front side of the camera body 11. The lens block 10 is provided at the front side, and the power unit 13 is provided at the rear side. Also, the handle 14 is provided on the top of the camera body 11, and the shoulder pad 15 is provided at the bottom to provide a cushion. The user holds the video camera at the shoulder pad 15 on his shoulder. Further, the video camera 1 has a tripod fixture 16 provided at the bottom of the camera body 11 and to which a tripod or the like is to be fixed, a viewfinder fixture 17 provided at the front side of the camera body 11 and to which the viewfinder 12 is to be installed, a first accessory-part fixture 18 provided at the top front of the camera body 11 and to which a microphone or the like is to be installed, a second accessory-part fixture 19 provided at the top rear of the camera body 11 and to which one of various accessory parts is to be installed, and a display unit connector 20 of the display unit 31 (which will be described in detail later), to which an interconnecting cord 49 is to be connected.

The camera body 11 includes photodetectors such as CCD (charge-coupled device) to image an object by detecting rays of light gathered by the imaging lens 21 and make a photoelectric conversion of the detected rays of light. Further, the camera body 11 includes an optical system such as a spectroscopic prism (not shown) which separates the rays of light gathered by the imaging lens 21 into red, green and blue components, namely, three primary colors, for example. Three CCDs are provided as the photodetectors correspondingly to the separated color components from the prism. Namely, the video camera 1 adopts the so-called 3-CCD system.

The camera body 11 includes a video signal processing circuit or the like which produces video signals correspondingly to the intensities of the rays of light detected by the CCDs. It should be noted that although the photodetectors are a CCD each in this example, they are not limited to the CCD but they may be a CMOS (complementary metal-oxide semiconductor device) or the like each as a photoelectric conversion device to attain a higher efficiency of the photoelectric conversion. Also, the 3-CCD system is just an example, to which the present invention is not limited.

Also, the camera body 11 includes a recording/playback block (not shown) to record the video signals from the photodetectors. The recording/playback block includes a recording medium receptacle for a tape cassette housing a magnetic tape as the recording medium, a hard disk, an optical disk or the like, and a magnetic head, optical pickup or the like which records and reproduces information signals such as video and audio signals to and from the recording medium set in the recording medium receptacle. Therefore, the camera body 11 is capable of recording video signals to the recording medium or reproducing information recorded in the recording medium.

Also, the camera body 11 reproduces video signals from the photodetectors and supplies them to the viewfinder 12. In this example, the camera body 11 incorporates the recording/playback block. According to the present invention, however, no such recording/playback block may be provided in the camera body 11 but a recording/playback block connected to an external output terminal may be used to record or reproduce information signals such as video signals.

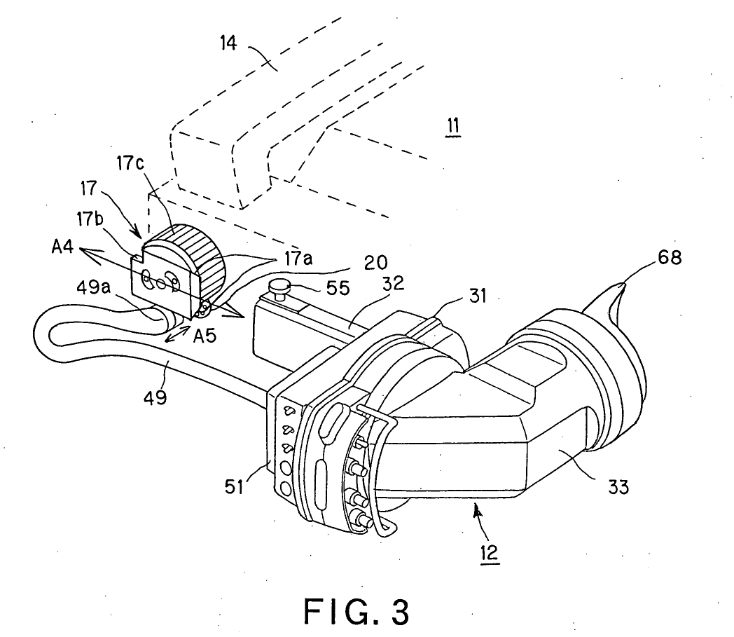

As shown in FIG. 3, the viewfinder 12 is installed removably to the viewfinder fixture 17 on the camera body 11. The viewfinder 12 is an image display by which the user can visually check video signals produced and reproduced by the camera body 11 or check a return video signal from outside the video camera 1. The viewfinder 12 can be pivoted within a range of 210 deg. in relation to the camera body 11 as indicated with arrows A1 to A3 in FIG. 2. It has a reference or home position where an eyepiece 68 (which will be described in detail later) will be directed backward when the user holds the video camera 1 with the shoulder pad 15 on his shoulder.

More specifically, positioning of the video camera 1 with the viewfinder 12 pivoted 90 deg. counterclockwise from the home position as indicated with the arrow Al in FIG. 2 is suitable for a shoot with the user's eyes being above the camera body 11, for example, namely, for a low-angle shoot.

Also, positioning of the video camera 1 with the viewfinder 12 pivoted 120 deg. counterclockwise from the home position as indicated with the arrow A2 in FIG. 2 is suitable for an upward shoot made by the user holding the camera body 11 in his arm, for example. With this positioning of the video camera 1, the user can check an image in the viewfinder 12 while holding the camera body 11 in his arm.

Further, positioning of the video camera 1 with the viewfinder 12 pivoted 90 deg. clockwise from the home position as indicated with the arrow A3 in FIG. 2 is suitable for a shoot made with the camera body 11 being above the user's eyes, for example.

The power unit 13 includes a battery which supplies a power to each of the components of the video camera 1. Namely, it drives the video camera 1.

The handle 14 is used by the user when carrying on the video camera 1 or holding the video camera 1 in a low shooting position. The video camera 1 can be held by gripping the handle 14 in hand.

The shoulder pad 15 is formed concave on the bottom of the camera body 11. The video camera 1 is held by the user putting the camera body 11 on his shoulder. The shoulder pad 15 is formed from a soft material to have a curved shape for fitting the user's shoulder.

The tripod fixture 16 has formed therein a screw hole in which a tripod 93 or the like is to be screwed for coupling the camera body 11 to the tripod.

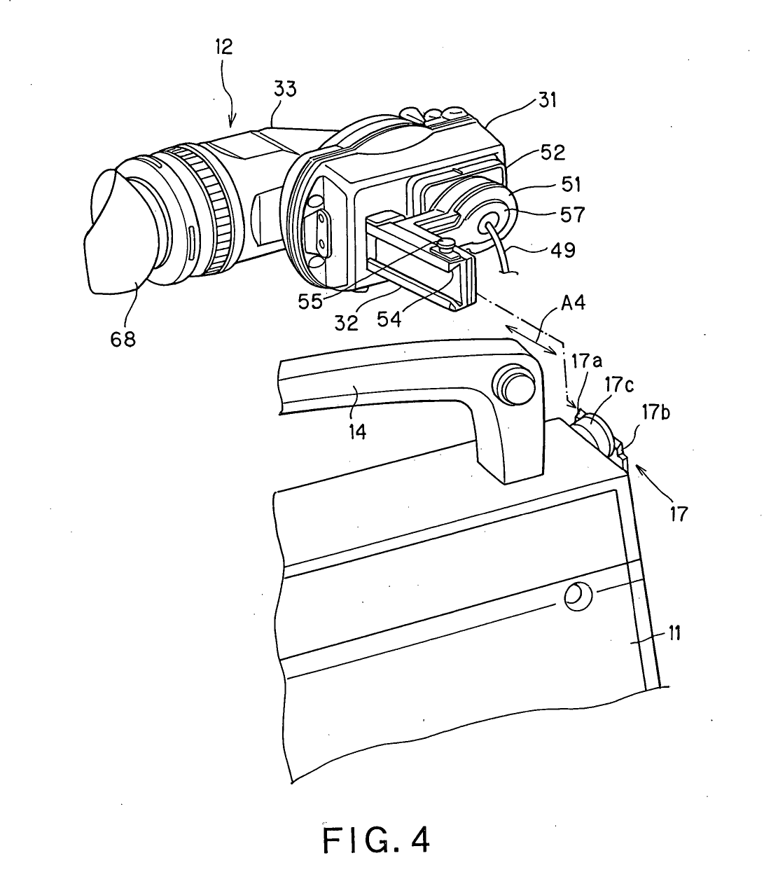

As shown in FIGS. 3 and 4, the viewfinder fixture 17 is to have the viewfinder 12 installed thereto. It is a plate-shaped member. When installing the viewfinder 12 to this fixture 17, the viewfinder 12 is introduced into the fixture 17 in the direction of arrow A4 in FIG. 3, and the fixture 17 is engaged in a guide recess 54 at the side of the viewfinder 12. On this account, the viewfinder fixture 17 is beveled (as indicated at a reference number 17a) at the upper and lower ends thereof for meeting the shape of the guide recess 54. Also, the viewfinder fixture 17 is cut at the upper end thereof opposite to the insertion end of the viewfinder 12 to provide a stopper 17b which cooperates with a lock pin 55 (which will be described in detail later), to prevent the viewfinder 12 once engaged from being disengaged when the viewfinder 12 is engaged at the guide recess 54 thereof onto the viewfinder fixture 17. Also, the viewfinder fixture 17 has provided at the side thereof opposite to the side on which the viewfinder 12 is installed a lock screw 17c which secures the viewfinder 12 to the camera body 11.

Each of the first and second accessory-part fixtures 18 and 19 has formed therein screw holes at which an accessory part such as a microphone can be fixed, and auxiliary screws are screwed in the screw holes.

The display unit connector 20 has connected thereto a connector 49a of the interconnecting cord 49 (which will be described in detail later) which connects the camera body 11 and viewfinder 12 electrically to each other. The connector 49a is connected or disconnected in the direction of arrow A5 in FIG. 3.

The viewfinder 12 installed removably to the viewfinder fixture 17 on the video camera 1 constructed as above will be described in detail below:

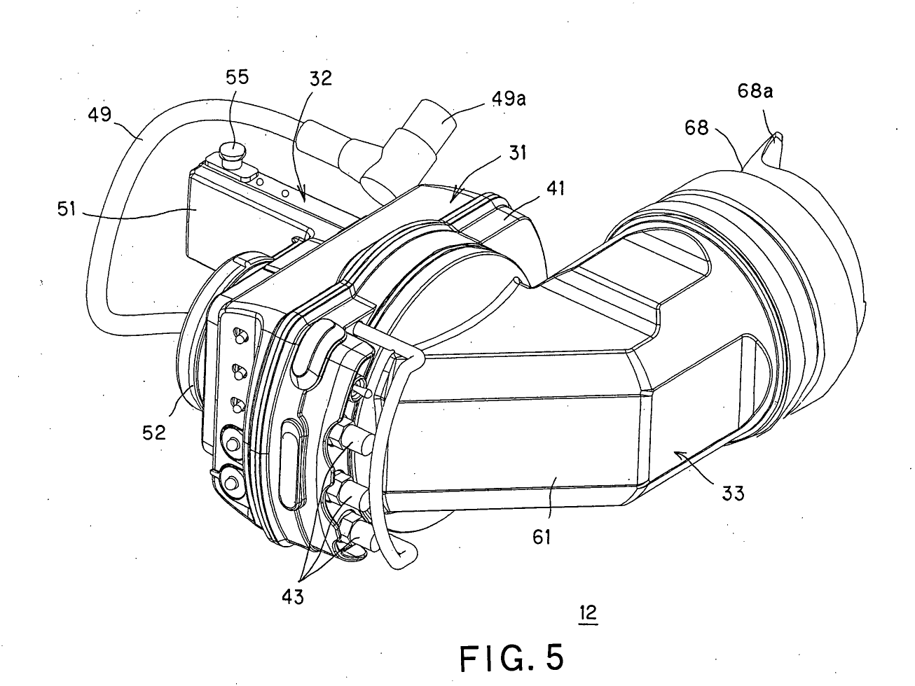

As shown in FIG. 5, the viewfinder 12 includes a display unit 31 to display an image, a mounting member 32 for installing the display unit 31 to the viewfinder fixture 17 of the camera body 11, and a finder block 33 to magnify an image displayed on the display unit 31.

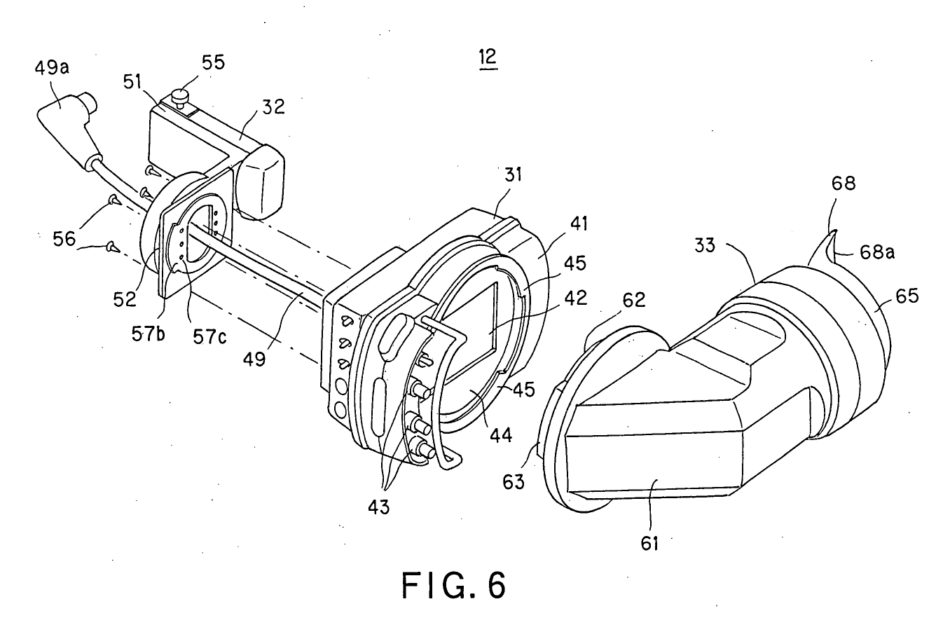

In the above viewfinder 12, the display unit 31, mounting member 32 and finder block 33 are removably coupled to each other as shown in FIG. 6. They can appropriately be coupled to, and decoupled from, each other appropriately, which will be described in detail later.

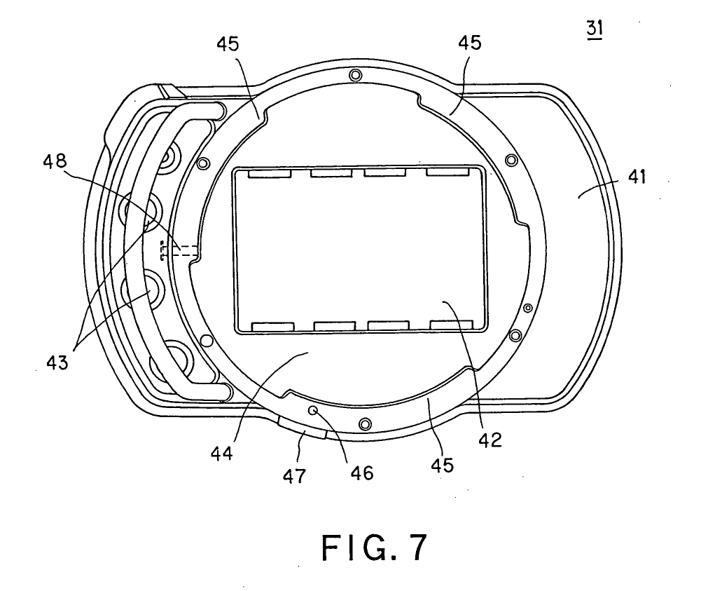

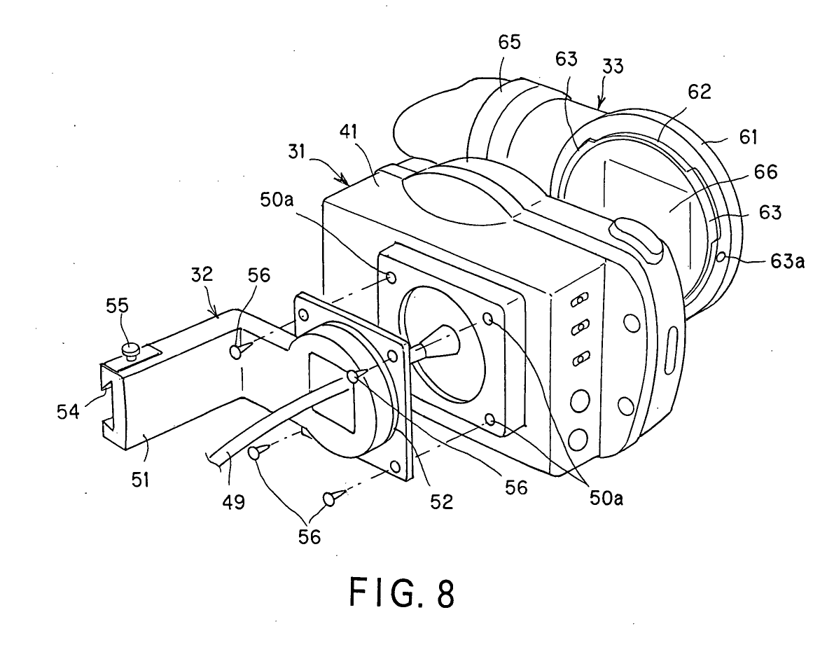

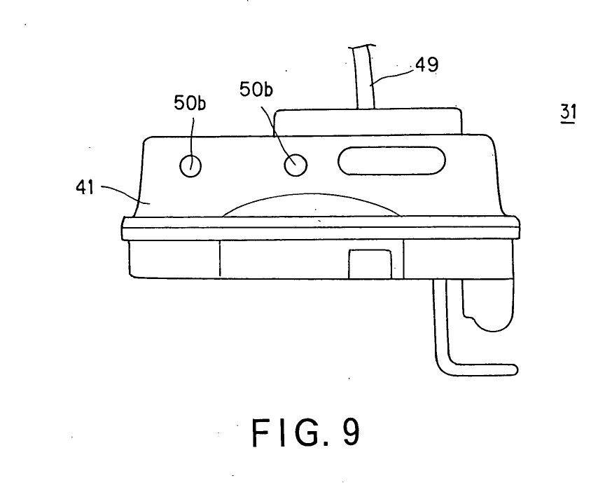

As shown in FIG. 7, the display unit 31 of the viewfinder 12 includes a body 41 of the display unit 31 itself, a liquid crystal display (LCD) panel 42 to display an image thereon, controls 43 to adjust an image displayed on the LCD panel 42, an installation opening 44 in which a cylinder 62 of the finder block 33, which will be described in detail later, is introduced, first coupling blades 45 which are engaged on second coupling blades 63 at the finder block 33, which will be described in detail later, a lock pin 46 for locking the finder block 33, an unlocking lever 47 for releasing the finder block 33 from the locking by the lock pin 46, and a sensor 48 for detecting when the finder block 33 is installed and locked. As shown in FIGS. 8 and 9, the viewfinder 12 further includes an interconnecting cord 49 for transmission of video signals to the LCD panel 42, screw holes 50a used for installation and fixation of the mounting member 32, and screw holes 50b used for installation and fixation of any other accessory part.

The display unit body 41 is shaped to be generally rectangular, and has the LCD panel 42 provided on the surface thereon as shown in FIG. 7. Also, the display unit body 41 has the interconnecting cord 49 led out therefrom and the mounting member 32 installed thereto at the rear side thereof as shown in FIG. 8.

The LCD panel 42 displays an image formed by rays of light projected from the back (a backlight, not shown), for example, according to video signals supplied from the camera body 11 via the interconnecting cord 49. The LCD panel 42 has a rectangular screen whose diagonal is about 2.7 inches long, for example.

The controls 43 provided to adjust the LCD panel 42 include various ones for adjusting an image displayed on the screen of the LCD panel 42. The controls 43 are to be operated by the user to adjust the brightness, contrast, color balance, display position, display range, etc.

The installation opening 44 is generally circular. The cylinder 62 of the finder block 33 is introduced into the opening 44. The LCD panel 42 will be positioned in the center of the opening 44.

The first coupling blades 45 are formed from a generally plate-shaped material to project inwardly into the installation opening 44. The first coupling blades 45 are disposed along every other ones of six equal circumferential divisions of a circle defined by the installation opening 44. The first coupling blades 45 are engaged on the second coupling blades 63 formed on the cylinder 62 of the finder block 33, introduced in the installation opening 44, to secure the finder block 33 to the display unit 31.

The lock pin 46 cooperates with an engagement hole 63a formed in a finder body 61 to form a locking mechanism which locks the display unit 31 and finder block 33 with the first coupling blades being engaged on the second coupling blades 63. The lock pin 46 penetrates through the first coupling blade 45 and is forced by an elastic member such as a coil spring away from the LCD panel 42. The lock pin 46 is engaged in the engagement hole 63a in the finder block 61, which will be described in detail later, to secure the finder block 33 to the display unit 31.

The unlocking lever 47 is provided to unlock the finder block 33 from the display unit 31. It moves the lock pin 46 forced away from the LCD panel 42 toward the latter, disengages the lock pin 46 from the engagement hole 63a in the finder body 61 and thus unlocks the finder block 33 from the display unit 31. The finder block 33 thus becomes pivotable.

The sensor 48 is provided to detect the state that the first and second coupling blades 45 and 63 are engaged on each other. It is forced by an elastic member to the center of the installation opening 44 and in a direction of forcing the second coupling blades 63. When the second coupling blades 63 are engaged on the first coupling blades 45, the sensor 48 is pressed by the second coupling blades 63 against the force, and detects the coupling of the display unit 31 and finder block 33 with each other. More particularly, as the finder block 33 is pivoted, the first and second coupling blades 45 and 63 are engaged on each other, and thus the sensor 48 will be forced by the end of the second engagement blade 63, that is downstream in the pivoting direction of the finder block 33. Thus, the sensor 48 is disposed in a position where it will be forced by the end of the second coupling blade 63, that is downstream in a direction in which the finder block 33 is pivoted. Forced by the end of the second coupling blade 63, the sensor 48 is connected to an inversion switch 84 included in a control circuit 81 which will be described in detail later to inform the inversion switch 84 of a detection.

The interconnecting cord 49 for electrical connection of the display unit body 41 to the camera body 11 is led from the back of the display unit body 41, and the connector 49a provided at the free end is connected to the display unit connector 20 provided on the camera body 11, as shown in FIGS. 3 and 8. Also, the interconnecting cord 49 is led from the back of the display unit body 41 along the axis passing through the center of pivoting of the viewfinder 12, which will be described in detail later.

The screw holes 50a are provided to fix the mounting member 32 to the display unit 31 with screws 56 (which will be described in detail later) as shown in FIG. 8. The screw holes 50b are provided to fix the display unit 31 to the first accessory-part fixture 18 or second accessory-part fixture 19 on the camera body 11, for example, or to any other place as shown in FIG. 9. Auxiliary screws or the like are provided tightened in these screw holes 50b.

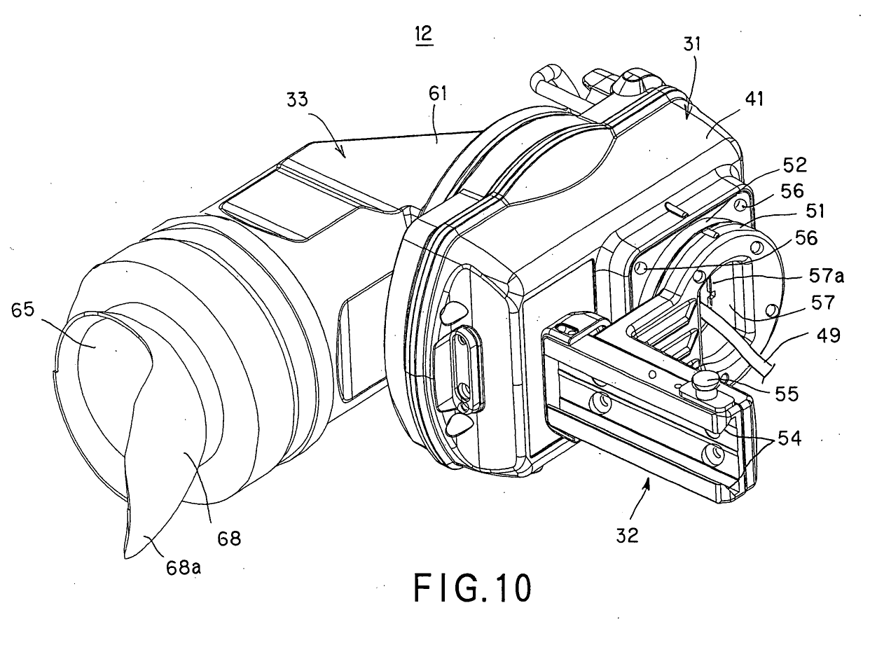

As shown in FIG. 10, the mounting member 32 of the viewfinder 12 includes a stationary portion 51 to be fixed to the camera body 11, and a pivoting portion 52 pivotably coupled to the stationary portion 51. The mounting member 32 is fixed to the camera body 11 with the stationary portion 51 being coupled at one side thereof to the viewfinder fixture 17 of the camera body 11. It abuts the pivoting portion 52 at the other side thereof Thus, the pivoting portion 52 is pivotable in relation to the stationary portion 51.

The stationary portion 51 has formed on the top and bottom thereof the guide recess 54 in which the viewfinder fixture 17 is engaged. The recess 54 is formed in a direction in which the viewfinder fixture 17 is inserted. The stationary portion 51 is installed to the viewfinder fixture 17 by sliding the viewfinder fixture 17 in the guide recess 54 the direction of arrow A4 in FIG. 3 with the beveled portion 17a formed on the viewfinder fixture 17 being inserted in the end of the guide recess 54.

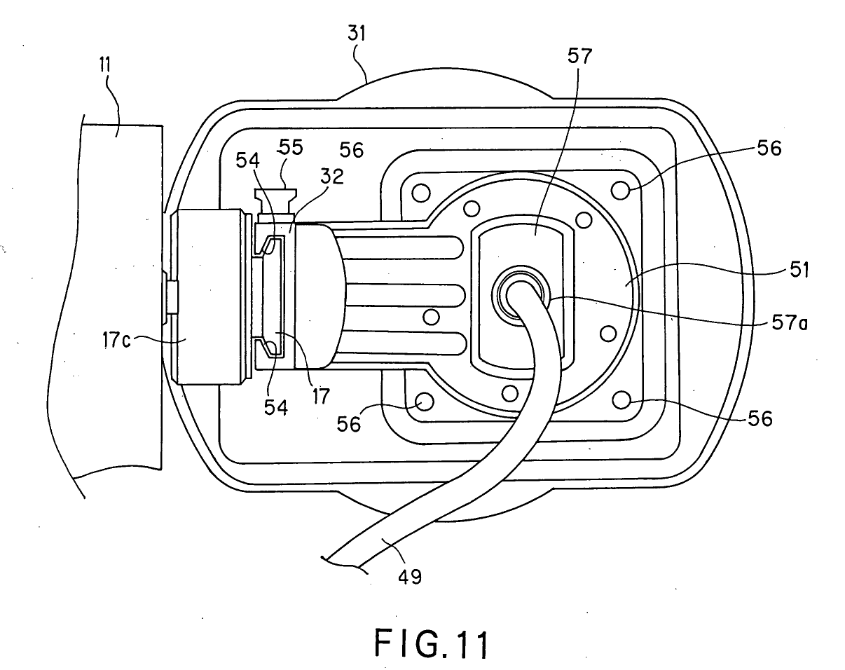

The stationary portion 51 has provided thereon the lock pin 55 corresponding to the stopper 17b of the viewfinder fixture 17. After installed to the viewfinder fixture 17, the stationary portion 51 is locked to the viewfinder fixture 17 by screwing the lock pin 55 toward the stopper 17b until it abuts the stopper 17b at the end thereof It should be noted that even with the lock pin 55 being engaged on the stopper 17b, the viewfinder 12 will not yet be completely fixed to the camera body 11. For the complete fixation, the lock screw 17c at the viewfinder fixture 17 is further driven into the stationary portion 51 as shown in FIG. 11. With this drive-in of the lock screw 17c into the stationary portion 51, the latter will be caught between the viewfinder fixture 17 and lock screw 17c and completely fixed to the viewfinder fixture 17. The viewfinder 12 can thus be installed to the camera body 11 by means of the fixing mechanism consisting of the stationary portion 51 of the mounting member 32 and the viewfinder fixture 17 provided in the camera body 11.

Also, as shown in FIGS. 6 and 10, there is formed on the side of the stationary portion 51 to which the pivoting portion 52 is coupled a shaft 57a through which the interconnecting cord 49 led out from the back of the display unit body 41 is passed. A flange 57 is formed all around the periphery, at one end, of the shaft 57a, and a retention plate 57b to retain the pivoting portion 52 is fixed to the other end, at the side of the display unit 31, of the shaft 57a with fasteners 57c such as a screw. As shown in FIG. 8, the shaft 57a extends through the pivoting portion 52, and the retention plate 57b provided at the other end is laid between the pivoting portion 52 and display unit 31.

As shown in FIG. 8, the pivoting portion 52 has the stationary portion 51 installed pivotably to one side thereon, and the display unit body 41 of the display unit 31 fixed to the other side. The pivoting portion 52 is fixed to the rear side of the display unit body 41 with the four screws 56 driven into the screw holes 50a formed at the rear side of the display unit 31.

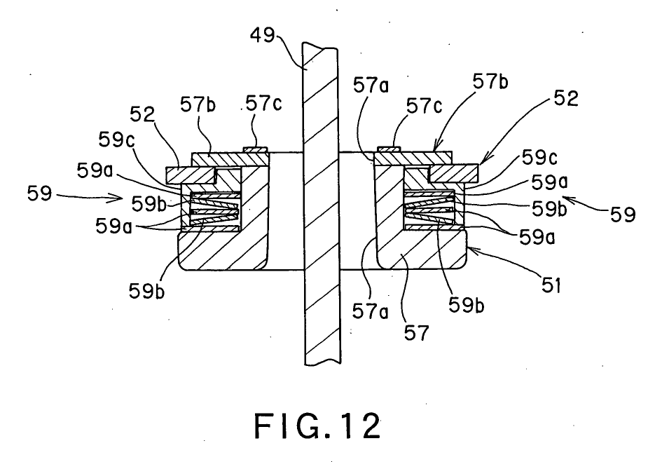

Also, a pivoting mechanism 59 to allow the pivoting portion 52 to pivot in relation to the stationary portion 51 is provided between the stationary portion 51 and pivoting portion 52. As shown in FIG. 12, the pivoting mechanism 59 provided between the stationary portion 51 and pivoting portion 52 is formed from a plurality of elastic members which force the flange 57 away from the pivoting portion 52. More specifically, the plurality of elastic members includes three washers 59a laid equidistantly, belleville springs 59b, and a washer case 59c housing the washers 59a and belleville springs 59b. The washer case 59c is open at one end thereof at the side of the flange 57, and so the washer 59a laid near the flange 57 abuts the latter.

The rotation of the pivoting portion 52 in relation to the stationary portion 51 of the mounting member 32 will be described in detail below. As shown in FIG. 12, the pivoting mechanism 59 has a washer case 59c disposed between the stationary and pivoting portions 51 and 52 and in which the washers 59a and belleville springs 59b are housed. The washer case 59c is forced by the washers 59a abutting the flange 57 to the pivoting portion 52, and the washer case 59c and pivoting portion 52 are retained by the retention plate 57b.

In the pivoting mechanism 59, each belleville spring 59b is disposed between the washers 59a and so it will be pressed by the adjoining washers 59a while each belleville spring 59b will press the adjoining washer 59a. Thus in the pivoting mechanism 59, the washer 59a is forced to the flange 57 and retention plate 57b, whereby the pivoting portion 52 laid between the washer case 59c and retention plate 57b is pivotable. Also, since the pivoting portion 52 slides with the flange 57 being forced by one, abutting the flange 57, of the washers 59a, the pivoting portion 52 is adjusted to be pivotable only when a friction will take place on the sliding surface and a torque larger than a value acts on the pivoting portion 52.

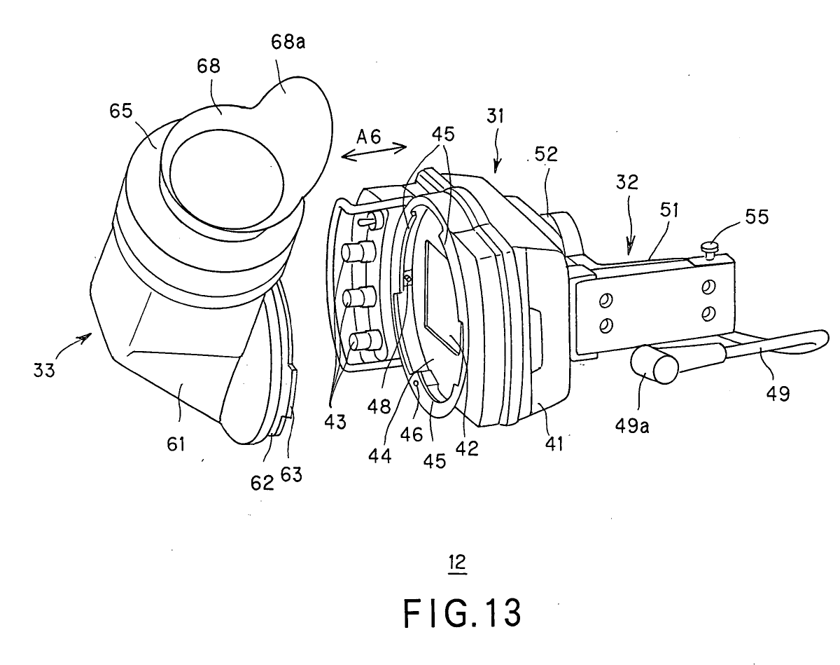

The finder block 33 of the viewfinder 12 is removably installed to the display unit 31 in the direction of arrow A6 in FIG. 13. The finder block 33 includes a body of the finder block 33, the cylinder 62 to be introduced in the installation opening 44 of the display unit 31, the second coupling blades 63 to be engaged on the first coupling blades 45 at the display unit 31, a mirror 64 which reflects the light from the LCD panel 42 of the display unit 31, and a magnifier 65 which magnifies the light reflected by the mirror 64, as shown in FIGS. 13 to 15.

The finder body 61 is a lens-barrel having an inner space in which the mirror 64 and magnifier 65 are provided and which assures to prevent external light from being incident upon the optical path along which the rays of light from the LCD panel 42 travel. Since the mirror 64 bends the optical path, so the finder body 61 is formed to have a generally L shape. The finder body 61 has the cylinder 62 provided at the side thereof where it is coupled to the display unit 31. Also, the finder body 61 has formed therein at the side thereof where the cylinder 62 is provided the engagement hole 63a in which the lock pin 46 is engaged when the finder block 33 is installed to the display unit 31, as shown in FIGS. 8, 16 and 17.

The cylinder 62 is inserted in the installation opening 44 of the display unit 31, and so it has a smaller diameter than a diameter defined by the first coupling blades 45 projecting inwardly of the inner wall of the installation opening 44. The cylinder 62 has the second coupling blades 63 provided along the inner-end periphery thereof.

The second coupling blades 63 are formed from a generally plate-shaped material and project outwardly of the inner-end periphery of the cylinder 62. More particularly, the second coupling blades 63 are disposed along every other ones of six equal divisions of the inner-end circumference of the cylinder 62. The second coupling blades 63 are engaged on the first coupling blades 45 formed at the installation opening 44 to secure the finder block 33 to the display unit 31.

To push up the sensor 48, a slope 63b is formed on one, of the plurality of second coupling blades 63, coming to a position near the sensor 48 and downstream in the pivoting direction of the second coupling blades 63 when the finder block 33 is installed to the display unit 31.

The above first and second coupling blades 45 and 63 form together a so-called bayonet mount, for example, in which blades are formed discretely in an annular shape not to overlap each other.

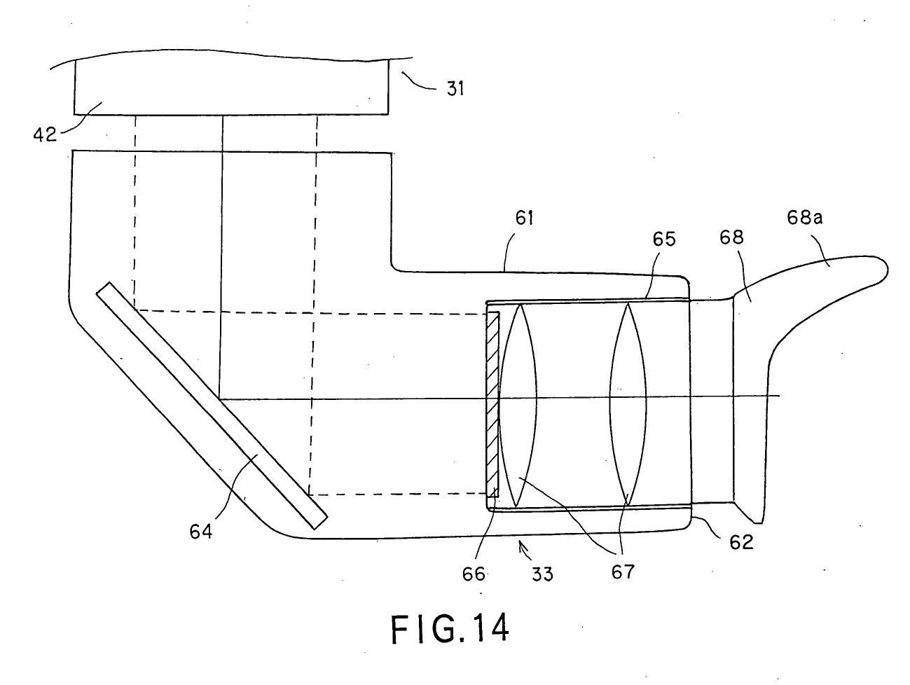

As shown in FIG. 14, the mirror 64 is disposed within the finder body 61 at an angle of 45 deg. with respect to the display screen of the LCD panel 42 of the display unit 31. It guides an image displayed on the LCD panel 42 to the magnifier 65 by turning the traveling direction of the rays of light from the LCD panel 42 by 90 deg. through reflection of the light.

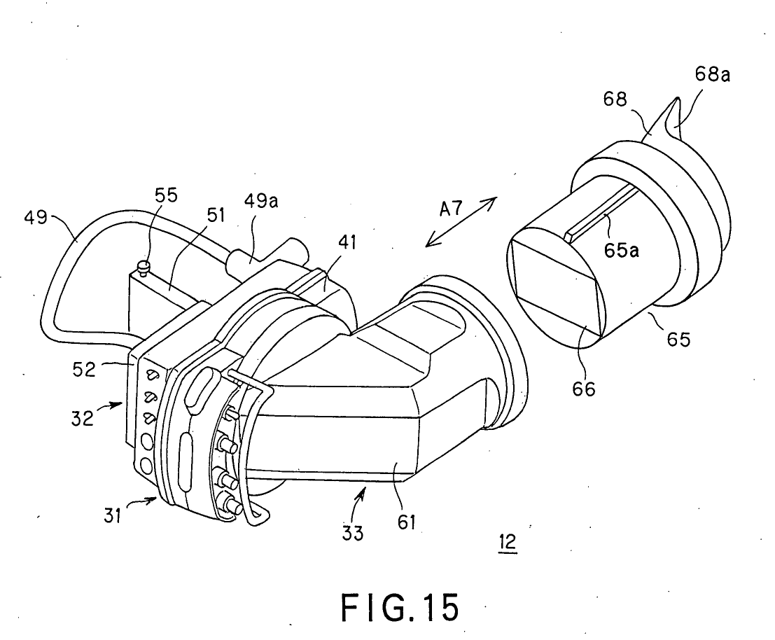

The magnifier 65 is an optical unit disposed in the finder body 61 to be removable in the direction of arrow A7 in FIG. 15. It includes a polarization filter 66 which attenuates the light traveling from outside to the LCD panel 42, a lens block 67 to magnify the light leaving the LCD panel 42 and passing through the polarization filter 66, and the eyepiece 68 disposed at the end thereof.

The magnifier 65 is to magnify an image displayed on the LCD panel 42 for checking the image. A hood 68a is provided on the eyepiece 68 to shut off the external light. The image is enlarged for display in the entire field of view of the user, which allows the user to concentrate on the image.

The polarization filter 66 attenuates the light traveling from the lens 67 to the LCD panel 42 to prevent an intense beam of light such as the sunlight from being condensed onto the LCD panel 42. The polarization filter 66 can cut the incident sunlight from the eyepiece 68 to about 1/7. It should be noted that the polarization filter 66 may be disposed in another place if it can attenuate the incident light from the eyepiece 68.

Note that taking account of the fact that the light output from the LCD panel 42 has been polarized, the transmittance of the light output can be made higher than that of the incident light from the eyepiece 68 by adjusting the axis of polarization so that the light output can easily pass through the polarization filter 66.

The lens block 67 is a magnification lens of a two-group construction to magnify an image displayed on the LCD panel 42.

The eyepiece 68 is provided with the hood 68a as above. The hood 68a is formed from a soft rubber since it is contact with the periphery of the user's eye.

In the finder block 33, since the magnifier 65 includes the lens block 67, the focal range of an image displayed on the LCD panel 42 to the user's eye depends upon the characteristic of the lens block 67. That is, in case the magnifier 65 is used, the position of the user checking the image will be limited. Namely, the user's eye off the eyepiece 68 can hardly check the image on the LCD panel 42.

In this case, an image displayed on the LCD panel 42 can be checked directly with the magnifier 65 removed from the finder block 33. More particularly, when the magnifier 65 is removed from the finder block 33, an image displayed on the LCD panel 42 is reflected by the mirror 64 and can thus be checked directly.

Also, if he viewfinder 12 is directed upward as shown in FIG. 2 and the magnifier 65 is positioned above the eyepiece 68, the finder block 33 will possibly condense the sunlight or the like onto the LCD panel 42.

More particularly, if the sunlight is condensed on the display screen of the LCD panel 42, the screen will be overheated and its surface screen will thermally be deformed. As a result, the LCD panel 42 will not normally function. Such a burning can be prevented by the polarization filter 66.

Also, if the magnifier 65 is removed from the finder block 33, the sunlight will possibly be incident upon the magnifier 65 and burn any thing under the magnifier 65. Even in this case, the polarization filter 66 can prevent such burning caused by the magnifier 65.

Even when the magnifier 65 has condensed the sunlight, the polarization filter 66 provided in the finder block 33 according to the present invention can attenuate the sunlight and thus minimize the possibility that the image display screen of the LCD panel 42 is overheated. Also, even when the magnifier 65 is removed from the finder block 33, it is possible to prevent the sunlight or the like from being condensed on the LCD panel 42 since the lens block 67 is provided in the magnifier 65, namely, since there exist no lens in the finder block 33. Also, even when the magnifier 65 is removed from the finder block 33 and left on a sheet of paper or the like, it is possible to prevent the sunlight or the like from being condensed and thus burning the paper.

Now, there will be described in detail how to install the finder block 33 constructed as above to the display unit 31 and the magnifier 65 to the finder block 33.

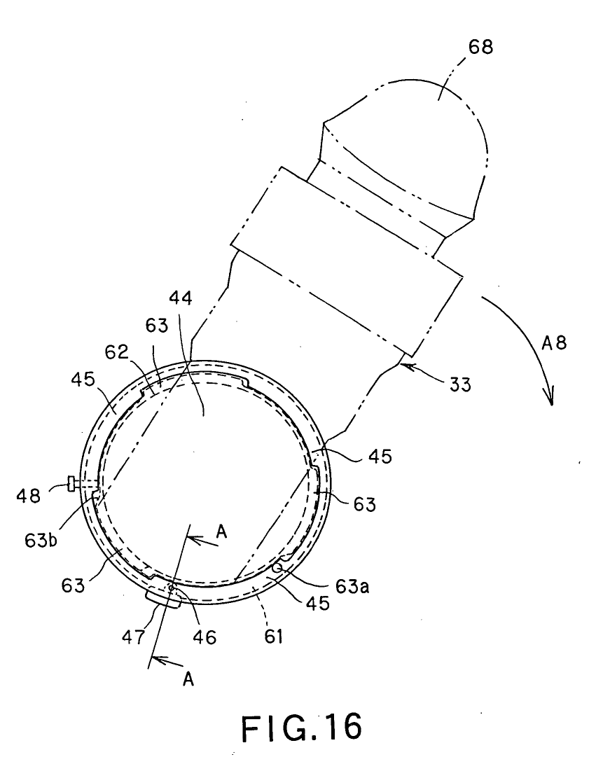

First, the cylinder 62 is fitted in the installation opening 44 in a direction in which the display unit 31 and finder block 33 are opposite to each other in such a manner the first coupling blades 45 of the display unit 31 and second coupling blades 63 of the finder block 33 will not overlap each other, as shown in FIG. 16. At this time, the finder block 33 is pivotable relative to the display unit 31 in the direction of arrow A8 in FIG. 16 since the first and second coupling blades 45 and 63 are displaced from each other in the direction in which the display unit 31 and finder block 33 are opposite to each other, that is, in the direction in which the finder block 33 is introduced into the display unit 31. Also, with the first and second coupling blades 45 and 63 being displaced from each other, the lock pin 46 penetrates through the first coupling blade 45 and is forced to the finder body 61 as shown in FIG. 18.

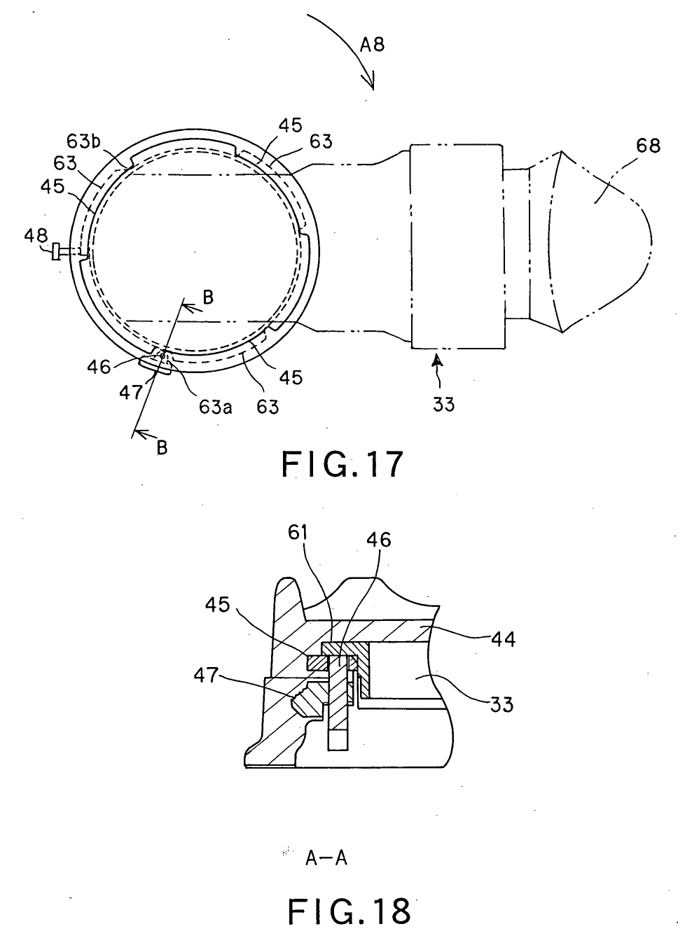

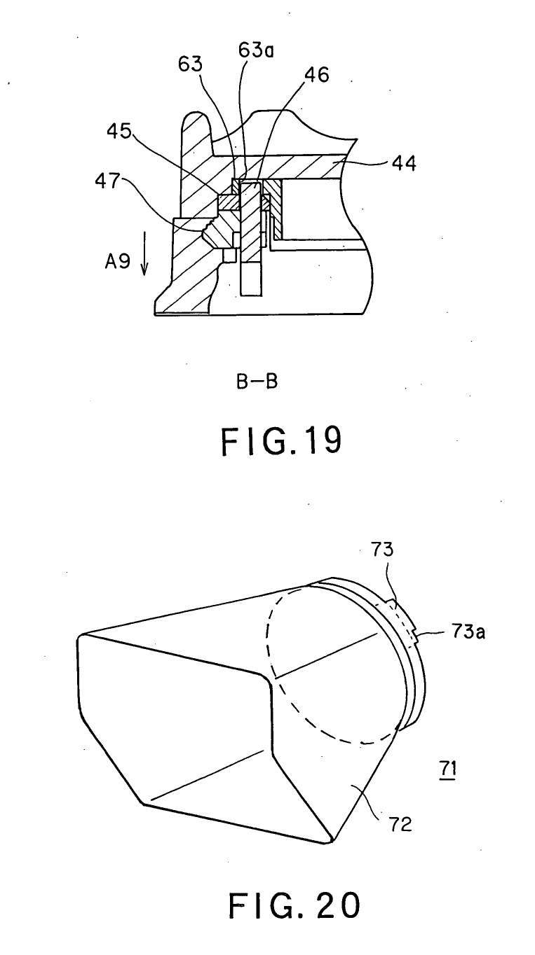

Next, the finder block 33 is pivoted relative to the display unit 31 in the direction of arrow A8 in FIG. 16. The second coupling blades 63 will slide between the first coupling blades 45 and the installation opening 44 in which the LCD panel 42 is provided, the other second coupling blades 63 will slide while pressing the sensor 48, and the first and second coupling blades 45 and 63 will overlap each other as shown in FIG. 17. In this condition, a part, downstream in the pivoting direction, of the second coupling blade 63 will push up the sensor 48. Also, since the lock pin 46 is forced to the finder block 61 as shown in FIGS. 17 and 19, it coincides with the position of the engagement hole 63a and thus it is engaged in the engagement hole 63a, and the finder block 33 is locked and fixed to the display unit 31.

Note that for removing the finder block 33 from the display unit 31, the unlocking lever 47 is moved in the direction of arrow A9 in FIG. 19 for the finder block 33 to move away from the display unit 31. Thus, the lock pin 46 is moved toward the LCD panel 42 and disengaged from the engagement hole 63a, resulting in unlocking. When the finder block 33 is pivoted relative to the display unit 31 in a direction opposite to the direction of arrow A8 in FIG. 16 with the unlocking lever 47 being pushed up, the first and second coupling blades 45 and 63 are displaced from each other as shown in FIG. 16, the finder block 33 can be removed from the display unit 31.

Note that for installing any accessory part other than the finder block 33 to the display unit, a cut is formed in coupling blades of the accessory part or the coupling blades are made shorter than the first coupling blades 45. That is, because of such a cut or reduced length of the coupling blade, the coupling blade will not press the sensor 48 when the accessory part is installed to the display unit 31. Thus, the sensor 48 will judge that the finder block 33 is not installed.

The other accessory parts to be installed to the display unit 31 include a hood 71, shown in FIG. 20, which shuts off external incident light upon the LCD panel 42 for easier viewing an image displayed on the LCD panel 42, and a magnifier 74, shown in FIG. 21, which magnifies an image displayed on the LCD panel 42.

In the hood 71, a portion corresponding to the top of the camera body 11 overhangs to shut off any intense light incident from above, especially, the sunlight, to enable definite checking of an image displayed on the LCD panel 42 even in the open air. As shown, the hood 71 includes a hood portion 72 to shut off external light and a third coupling blade 73 which is engaged on the first coupling blades 45 of the display unit 31. It should be noted that the third coupling blade 73 has a cut 73a formed therein.

The magnifier 74 uses a lens whose diameter is larger than that of the magnifier 65 in the finder block 33 and thus provides a larger image than the magnifier 65. The magnifier 74 includes a lens 75 to magnify an image displayed on the LCD panel 42 and a fourth coupling blade 76 which is engaged on the first coupling blades 45 of the display unit 31. It should be noted that the fourth coupling blade 76 has a cut 76cformed therein.

Note that the other accessory part to be installed to the display unit 31 is not limited to the hood 71 or magnifier 74 but a variety of accessory parts suitable for checking an image displayed on the LCD panel 42, for example, a combination of a hood and magnifier may be installed to the display unit 31.

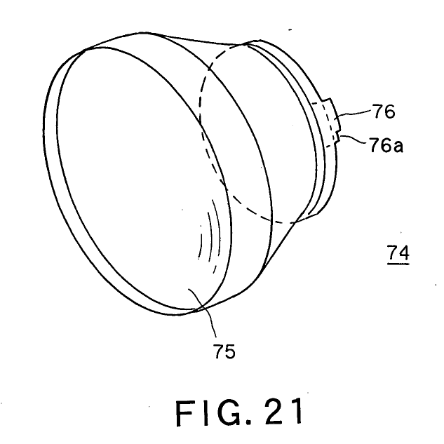

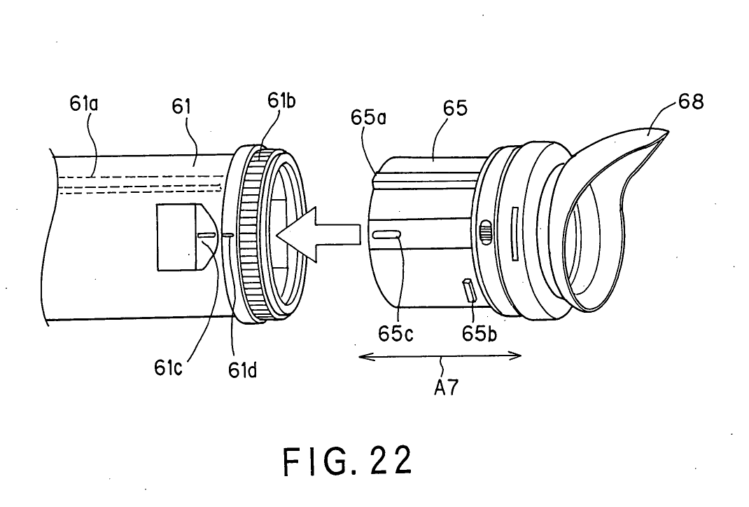

Next, there will be explained how to install the magnifier 65 to the finder block 33. As shown in FIGS. 22 and 23, the magnifier 65 has an engagement projection 65a formed thereon. With the engagement projection 65a being engaged in an engagement concavity 61a formed in the inner wall of the finder body 61, the magnifier 65 is fixed to the finder block 33 against any rotation. The inner wall of the finder body 61 is formed to fit the outer surface of the magnifier 65 so that the latter can only be inserted in one direction. Also, the magnifier 65 is inserted into the finder body 61 with a mark 61c formed on the finder body 61, mark 61d formed on a lock ring 61b and a mark 65c formed on the magnifier 65 being aligned with each other. With the marks 61c, 61d and 65c being put in line with each other, the magnifier 65 will be fixed to the finder body 61 for the axis of polarization of the polarization filter 66 to coincide with the polarized direction of the light output from the LCD panel 42.

After inserting the magnifier 65 into the finder body 61, the lock ring 61b provisionally pre-fixed to the opening of the finder body 61 is rotated in the direction of arrow A10 in FIG. 23, whereby a projection formed inside the lock ring 61b will be engaged in a recess 65b formed in the outer surface of the magnifier 65. Thus, the magnifier 65 is fixed to the finder body 61.

In the finder block 33, however, since an image is reflected by the mirror 64, the image magnified by the magnifier 65 will be an inverted image, namely, a mirror image, which is different from an image having actually been captured by the video camera.

On this account, the sensor 48 is provided in the display unit 31 to detect when the finder block 33 is installed in place. In case the finder block 33 is installed in place, the video camera 1 is controlled to invert an image displayed on the LCD panel 24 so that the user can check, through the eyepiece 68, a normal image, not any inverted one.

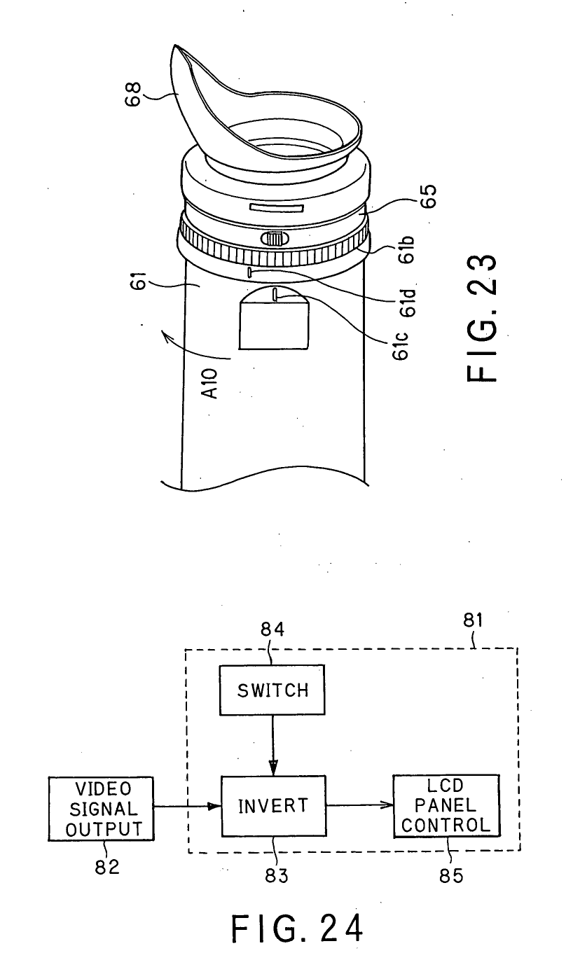

More specifically, the control circuit 81 includes, as shown in FIG. 24, a video signal output unit 82 to provide video signals for view-finding, an image inversion unit 83 to invert an image on the basis of the video signals from the video signal output unit 82, an inversion switch 84 to turn on and off the image inversion unit 83, and an LCD panel controller 85 to drive the LCD panel 42 on the basis of the video signals inverted by the image inversion unit 83.

The video signal output unit 82 is a circuit to provide video signals from the lens block 10 or those reproduced by the recording/playback unit in the camera body 11 for the purpose of view-finding.

The image inversion unit 83 is a signal processing circuit to invert an video signal output from the video signal output unit 82. When the inversion switch 84 is turned on, the image inversion unit 83 inverts and supplies video signals to the LCD panel controller 85. When the inversion switch 84 is off, the image inversion unit 83 will not invert such video signals but provides the signals as they are to the LCD panel controller 85.

The inversion switch 84 is connected to the sensor 48. When pressed to the second coupling blades 63, the sensor 48 will detect when the finder block 33 is installed to the display unit 31, and then it puts the image inversion unit 83 into operation. Also, when not pressed to the second coupling blades 63, the sensor 48 will detect when the finder block 33 is not installed to the display unit 31. In this case, it will turn off the image inversion unit 83. The LCD panel controller 85 will drive the LCD panel 42 on the basis of video signals from the image inversion unit 83 to display an image on the LCD panel 42.

Even if the aforementioned accessory such as the hood 71, magnifier 74 or the like is installed to the display unit 31, the image will not be inverted since the accessory includes no mirror. When the hood 71 or magnifier 74 is installed to the display unit 31, the inversion switch 84 will not be turned on since the hood 71 or magnifier 74 has the third or fourth cut 73a or 76a formed in a portion thereof, where the third or fourth coupling blade 73 or 76 will abut the sensor 48. Therefore, the image inversion unit 83 will provide video signals, not inverted, to the LCD panel controller 85.

A variety of accessories may be used with the display unit 31 by forming a cut like the cut 73a or 76a as above in an coupling blade of such an accessory, which is to be engaged on the first coupling blades 45, in case it is not necessary to invert video signals. The control circuit 81 makes such a switching that an image displayed on the LCD panel 42 will be a normal one for the user.

Note that although the control circuit 81 is provided in the viewfinder 12 in this embodiment, a part or all thereof may be provided in the camera body 11.

The viewfinder 12 constructed as above is installed pivotably to the camera body 11 as shown in FIG. 2. The viewfinder 12 is pivoted in relation to the camera body 11 by means of the pivoting mechanism 59 provided between the stationary portion 51 and pivoting portion 52 of the fixing member 32. The pivoting is independent of the display unit 31. Also in the viewfinder 12, the interconnecting cord 49 is led out from the display unit 31 through the shaft 57a formed in the stationary portion 51 as shown in FIG. 12. Namely, the interconnecting cord 49 is also independent of the pivoting. Therefore, when the viewfinder 12 is pivoted in relation to the camera body 11, the interconnecting cord 49 will not possibly be kinked.

Namely, since the viewfinder 12 has the interconnecting cord 49 led out from the center of pivoting of the display unit 31, the interconnecting cord 49 can be sufficiently slack and will not considerably be kinked locally even when the display unit 31 is pivoted.

Thus, the interconnecting cord 49 of the viewfinder 12 can be prevented from being broken by any kink. Namely, it is not possible that an image displayed on the LCD panel 42 of the display unit 31 will disappear suddenly.

When using the video camera to pick up a movie, the video camera is fixed on a tripod or the like and the user sits on a chair or the like placed behind the video camera as the case may be. Since the eyepiece of the viewfinder is apart from the user in such a case, a long viewfinder will be necessary. The long viewfinder has a long optical path because the lens-barrel is long, and it is correspondingly expensive.

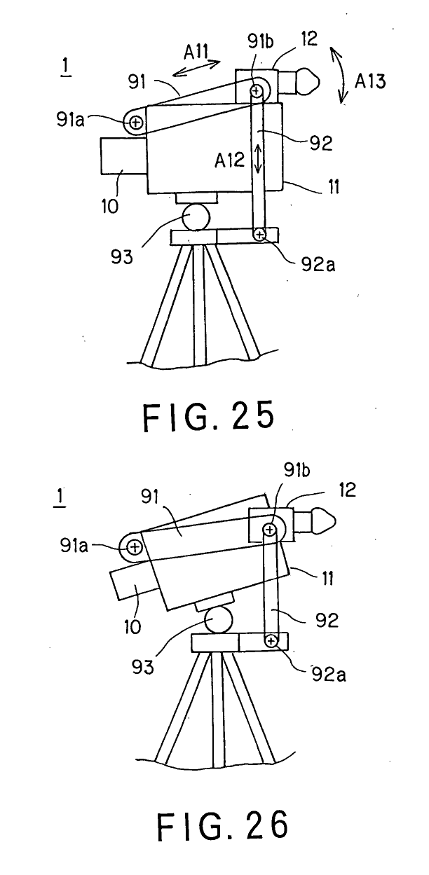

In the video camera 1 according to the present invention, however, the viewfinder 12 is removably installed to the camera body 11. When the camera body 11 is fixed atop a tripod 93 as shown in FIGS. 25 to 27, the viewfinder 12 can be supported behind the camera body 11 by a first arm member 91 extended backward from the viewfinder fixture 17 and a second arm member 92 which supports the first arm member 91 at one rear point as shown in FIG. 25. Thus, the viewfinder 12 according to the present invention can be used a long viewfinder.

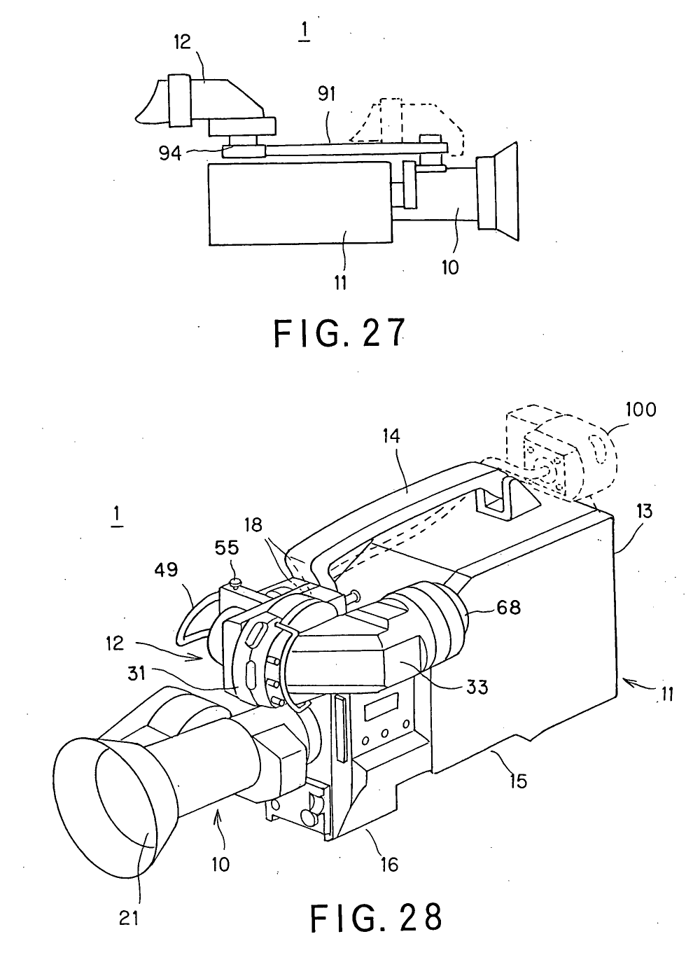

The first arm member 91 is formed from a light metal such as aluminum or titanium to have a bar-like shape. The first arm member 91 is pivotably connected at one end thereof to the viewfinder fixture 17 at the camera body 11 taking the fixture 17 as fulcrum 91a, and supported on the second arm member 92 for the other end to be positioned at the back of the camera body 11. The first arm member 91 has fixed at the other end thereof a bracket 94 to support the viewfinder 12 as shown in FIG. 27. The viewfinder 12 is installed via the bracket 94 to be movable longitudinally of the first arm member 91, that is, in the direction of arrow All in FIG. 26.

The second arm member 92 is formed from a light metal such as aluminum or titanium to have a bar-like shape. The second arm member 92 is pivotably connected at one end thereof to the tripod 93 taking a part of the tripod 93 as a fulcrum 92a, and connected by the first arm member 91 for the other end thereof to be positioned at the back of the camera body 11 to support the first arm member 91. To support the first arm member 91, the second arm member 92 is designed to be telescopic in the direction of arrow A12 in FIG. 25. For example, the second arm member 92 may be designed to have a hydraulic damper mechanism allowing a smooth telescopic operation. The first and second arm members 91 and 92 are positioned to be connectable with each other and pivotable in relation to each other at a fulcrum 91b.

The tripod 93 is fixed on an installation surface, and the camera body 11 is coupled at the tripod fixture 16 thereof to the top of the tripod 93 with a screw (not shown). Thus, the video camera 1 is supported on the tripod 93. The tripod 93 allows the video camera 1 to be turned, namely, panned or tilted in a desired direction.

When capturing an object staying in front of the lens block 10, the video camera 1 is supported horizontally on the tripod 93 as shown in FIG. 25. For picking up an object positioned below the lens block 10 of the video camera 1, the video camera 1 is supported on the tripod 93 for the lens block 10 to be directed downward as shown in FIG. 26.

When the video camera 1 is tilted in the direction of arrow A13 in FIG. 25, the viewfinder 12 can be kept stationary in a generally a constant position corresponding to the user's head since it is supported on the first and second arm members 91 and 92.

More particularly, in case the video camera 1 is down-tilted as shown in FIG. 26, the fulcrum 91a is normally displaced downward following up with the camera body 11. Since the first arm member 91 is pivoted about the fulcrum 91a, the displacement of the viewfinder 12 installed to the rear side of the first arm member 91 will be vanishingly small. This is because the first arm member 91 at the fulcrum 91b thereof can be kept at a generally constant height since the firs arm member 91 is supported at the fulcrum 91a by the second arm member 92 which is telescopic.

As having been described above, the polarization filter 66 provided in the removable magnifier 65 in the finder block 33 of the video camera 1 according to the present invention prevents the display screen of the LCD panel 42 from being heated by the sunlight or the like which is incident from the eyepiece 68 and condensed by the lens block 67, namely, the LCD panel 42 from thus being defective. Also, the polarization filter 66 prevents the magnifier 65, if removed from the finder block 33, from condensing the sunlight or the like, resulting in burning of any sheet of paper or the like.

Also, since the viewfinder 12 of the video camera 1 is installed removably to the camera body 11, it can be installed to a desired position on the camera body 11. Using the lightweight members such as the first and second arm members 91 and 92, the viewfinder 12 can be positioned at the back of the camera body 11, which makes it unnecessary to use any expensive long viewfinder.

Also, since the video camera 1 with the viewfinder 12 according to the present invention can function equally to a video camera provided with an expensive and heavy long viewfinder, it can be used inexpensively. And, since the first and second arm members 91 and 92 are simple and lightweight, they can easily be carried and handled. Also, the first and second arm members 91 and 92 are simply-designed and thus hardly defective.

Further, since the finder block 33 including the magnifier 65 in the viewfinder 12 is installable removably to the display unit 31, it is possible to magnify an image displayed on the LCD panel 42 of the display unit 31 by the magnifier 65 as well as to directly view the image on the LCD panel 42 with the finer block 33 being removed. Thus, with the video camera 1, a plurality of users can check an image displayed on the LCD panel 42 simultaneously. Also, the video camera 1 has not to be connected to any external monitor when reproducing video signals recorded in the recording/playback unit. The viewfinder 12 will function as the monitor. Thus, video shooting can be made in any remote place with less imaging equipment and materials.

Moreover, when the viewfinder 12 is pivoted in relation to the camera body 11, the interconnecting cord 49 can be prevented from being kinked and broken because it is led out independently of the pivotable fixing member 32, which will lead to an improved reliability of the video camera 1.

Note that in the aforementioned video camera 1, since the viewfinder 12 is removably installable to the display unit 31, the viewfinder 12 may be installed to the first accessory-part fixture 18 or second accessory-part fixture 19 on the camera body 11 by the use of an auxiliary screw and the screw hole 50b at the display unit 31.

Also, besides the viewfinder 12, a viewfinder 100 generally similar to the viewfinder 12 may be used by fixing it to the first or second accessory-part fixture 18 or 19 of the camera body 11 of the video camera 1 with the auxiliary screw.

More specifically, by installing the viewfinder 12 with on the display unit 31, instead of the viewfinder 12 fixed to the viewfinder fixture 17, to the second accessory-part fixture 19 as shown in FIG. 28, the user can concentrate on an object image through the viewfinder 12 or a plurality of other uses can view the image directly through the above viewfinder 100.

The video camera 1 having been described in the foregoing is suitably usable in a collaboration work such as a movie making by many people since multiple persons can simultaneously check an image being captured.

In the foregoing, the present invention has been described in detail concerning certain preferred embodiments thereof as examples with reference to the accompanying drawings. However, it should be understood by those ordinarily skilled in the art that the present invention is not limited to the embodiments but can be modified in various manners, constructed alternatively or embodied in various other forms without departing from the scope and spirit thereof as set forth and defined in the appended claims.

What is claimed is:

1. A video camera comprising:
a camera body to image an object; and
a viewfinder removably installed on the camera body to display an image picked up by the camera body,
the viewfinder including a display unit to display an image thereon, and a mounting member removably installable to a finder fixture on the camera body so that the display unit is pivotably installed on the camera body; and
the camera body having provided thereon an accessory-part fixture for fixing an accessory part to the video camera.

2. The video camera as set forth in claim 1, wherein:
the finder fixture is provided at the front side of the camera body and has removably installed thereto an arm member extending from the front to rear side of the camera body; and
the display unit is removably installed to the arm member.

3. The video camera as set forth in claim 1, wherein the display unit is removably installable to the accessory-part fixture.

4. The video camera as set forth in claim 1, wherein at least either the accessory-part fixture or display unit has an auxiliary screw provided thereon.

5. A magnifier comprising:
a magnification lens provided in a viewfinder to magnify an image displayed on a display unit; and
a polarization filter provided on an optical path of the magnifier,
and wherein the magnifier is removably installable to the viewfinder.

6. A viewfinder comprising:
a display unit having a display screen to display an image; and
a magnifier having a magnification lens to magnify an image displayed on the display screen,
the magnifier having a polarization filter provided on an optical path thereof.

7. The viewfinder as set forth in claim 6, wherein the magnifier is removably installable to the display unit.

8. A video camera comprising:
a camera body to image an object; and
a viewfinder,
the viewfinder including a display unit having a display screen to display an image thereon; and a magnifier having a magnification lens to magnify an image displayed on the display screen; and
the magnifier having a polarization filter provided on an optical path thereof.

9. The video camera as set forth in claim 8, wherein the magnifier is removably installable to the display unit.
